(19) United States
(12) Patent Application Publication
(10) Pub. No.: US 2006/0047463 A1
(43) Pub. Date: Mar. 2, 2006

(54) Bit synchronization for high-speed serial device testing

(76) Inventors: A. T. Sivaram, Saratoga, CA (US); Howard Maassen, San Jose, CA (US)

Correspondence Address: PATTERSON & SHERIDAN, L.L.P., 3040 POST OAK BOULEVARD, SUITE 1500, HOUSTON, TX, 77056, US

(21) Appl. No.: 10/948,709

(22) Filed: Sep. 23, 2004

Related U.S. Application Data
(63) Continuation-in-part of application No. 10/924,675, filed on Aug. 24, 2004.

(51) Int. Cl. G06F 19/00

(52) U.S. Cl. 702/120; 702/117

(57) ABSTRACT

An apparatus for testing electronic devices that output high-speed serial data bit streams employs a programmable device to adjust the timing of the strobe so that the data bit stream being analyzed is strobed at or near the center of the bit. The programmable device sets a number of different reference strobe points that are used to strobe the data bit streams. The different reference strobe points span a single bit interval at regular intervals. The programmable device evaluates the strobe readings generated with the different reference strobe points and selects one of them as the one to be used during testing. The selection is made during the initialization phase of testing or intermittently while the test is being carried out.

### RELATED APPLICATION

This application is a continuation-in-part of application Ser. No. 10/924,675, filed Aug. 24, 2004, entitled “Non-Deterministic Protocol Packet Testing.”

### BACKGROUND OF THE INVENTION

1. Field of the Invention

The present invention relates generally to electronic device testing, and more particularly, to synchronization techniques used in testing integrated circuit (IC) devices that output high-speed serial data streams.

2. Description of the Related Art

Next generation microprocessors will use a large number of high-speed serial links to communicate with external memory and I/O devices. In order to obtain accurate test results of such microprocessors, it is important that the continuous stream of bits (0's and 1's) output by them is consistently strobed near the center of the bit and away from the transitions between the bits. If the strobes are positioned near the bit transitions, inaccurate strobe readings, e.g., 0 strobed as a 1 or 1 strobed as a 0, might result and cause inaccurate test results.

A conventional automated test equipment (ATE) uses a binary search method to locate the center of the bit. The binary search method is carried out during the initialization phase of testing when the device under test is outputting an alternating stream of 0's and 1's. With this method, two strobe points separated by the bit interval are initially selected. Then, a third strobe point that is halfway between the initial two strobe points is selected. The reading from the third strobe point is compared with the readings from the first two, and the pair that exhibits a transition (0 to 1 or 1 to 0) is selected as end points of a fourth strobe point that is halfway between the pair. The reading from the fourth strobe point is compared with the readings from the end points, and the pair that exhibits a transition (0 to 1 or 1 to 0) is selected as end points of a fifth strobe point that is halfway between the pair. This process is repeated until the bit transition is identified with a predetermined degree of accuracy. The bit strobe position is then computed as the position of the bit transition plus one-half of the bit interval.

The binary search method used in the conventional ATE, as described above, is too slow and cannot be used while a test is ongoing. As a result, they are unable to correct for bit misalignments that may result during testing, e.g., during clock starts and stops, and from drifts caused by heating up or cooling down of the device.

### SUMMARY OF THE INVENTION

The invention is directed to a bit synchronization method, and an apparatus implementing such a method, for adjusting the timing of the strobe during initialization and testing so that the data bit stream being analyzed is consistently strobed near the center of the bit.

The invention implements bit synchronization techniques that employ a programmable device, such as a field programmable gate array (FPGA). The programmable device selects from a number of different time sets that are used to strobe the data bit stream. Each of the different time sets positions the strobe at a unique reference strobe position along a single bit interval. The programmable device evaluates the strobe readings generated using the different time sets and selects one of the time sets as the one to be used for subsequent strobing of the data bit streams.

More specifically, for each time set, the programmable device records the number of zeroes that are read from a predefined data bit stream of alternating 0's and 1's within a set time period. The time set that generates the most number of zeroes is selected as the one to be used for subsequent strobing of the data bit streams. If multiple time sets generate the most number of zeroes, the time set that is at or near the center of the largest contiguous block of such time sets is selected as the one to be used for subsequent strobing of the data bit streams.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a tester and a device under test;

FIG. 2 is a block diagram showing an instrument used in the tester of FIG. 1 in more detail;

FIG. 3 is a block diagram showing a component of the instrument depicted in FIG. 2 in more detail;

FIG. 4 is a block diagram of a frame synchronization module implemented in the component of FIG. 3;

FIGS. 5A and 5B are flow diagrams that illustrate a method for testing electronic devices that exhibit non-deterministic behavior;

FIG. 6 illustrates a bit stream output by the device under test during the initialization phase of testing;

FIG. 7 is a flow diagram that illustrates the bit synchronization method carried out during initialization phase of testing;

FIG. 8 illustrates a bit stream output by the device under test during testing; and

FIG. 9 is a flow diagram that illustrates the bit synchronization method carried out during testing.

### DETAILED DESCRIPTION

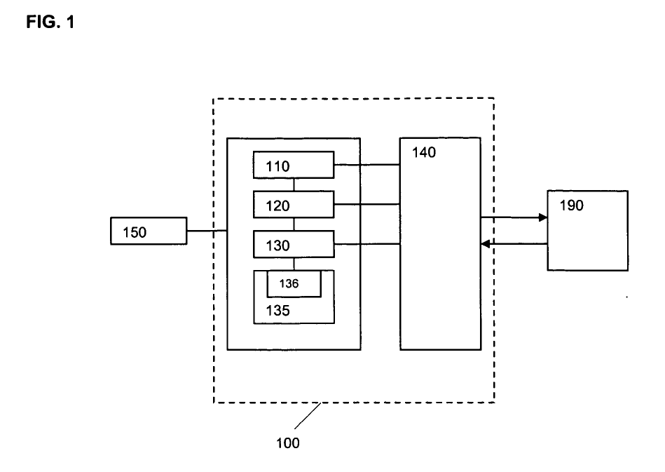

FIG. 1 is a block diagram of a tester 100 that is used in testing electronic devices. The tester 100 includes a number of slots in which a number of instruments are inserted. The instruments include a device power supply (DPS) 110 for supplying power to a device under test (DUT) 190, analog test instruments 120 for supplying test signals to input analog pins of the DUT 190 and receiving response signals from output analog pins of the DUT 190, digital test instruments 130 for supplying test signals to input digital pins of the DUT 190 and receiving response signals from output digital pins of the DUT 190, a test head interface 135 which houses a master clock 136, and a fixture 140, known in the art as a loadboard, for providing a connection interface between the instruments 110, 120, 130 and the DUT 190. During testing, the tester 100 operates under the control of software, e.g., a test program 150. The bus architecture of the tester 100 by which the instruments 110, 120, 130, 135 communicate with each other, and other details of the tester 100, are described in U.S. patent application Ser. No. 10/222,191, entitled “Circuit Testing with Ring-Connected Test Instrument Modules,” filed Aug. 16, 2002, which is incorporated by reference herein.

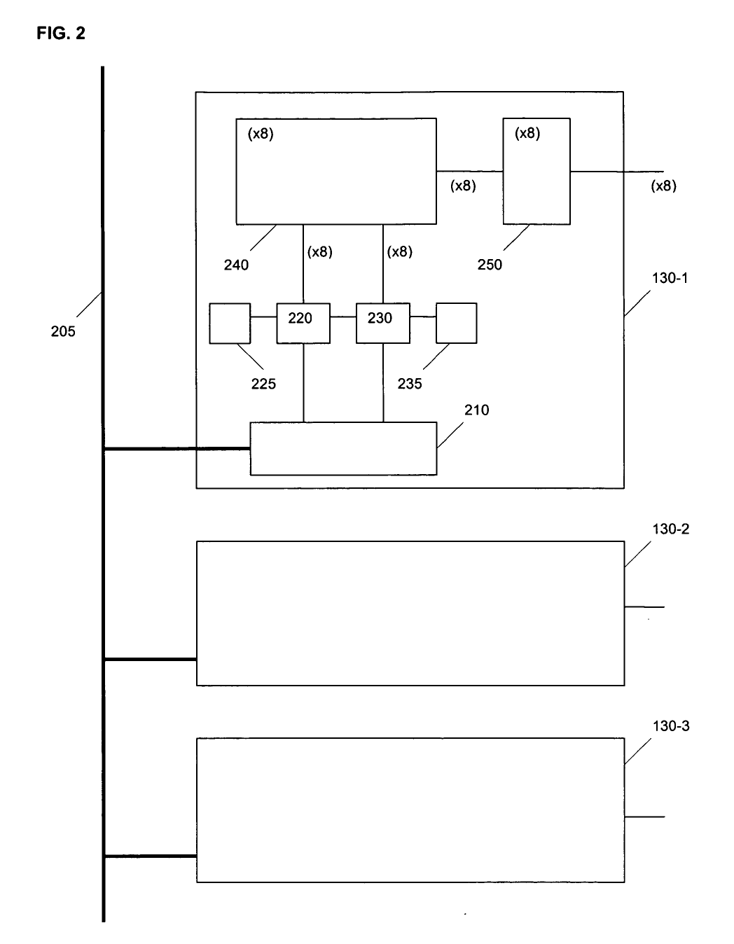

FIG. 2 is a block diagram of digital test instruments 130-1, 130-2, 130-3 that communicate with each other over a system bus 205. Each of the digital instruments 130 comprises substantially the same circuitry. For simplicity, the circuitry of only the digital instrument 130-1 is illustrated in FIG. 2.

In the preferred embodiment, the digital instrument 130-1 includes a bus interface field programmable gate array (FPGA) 210, a pair of FPGAs 220, 230 and their associated dual inline memory modules (DIMMs) 225, 235, eight timing generation circuits 240 (only one of which is illustrated), and eight pin electronics circuits 250 (only one of which is illustrated). Each of the timing generation circuits 240 is connected to a different one of the pin electronics circuits 250, and each of the eight pin electronic circuits 250 is connected to a different digital pin of the DUT 190 through the fixture 140. There are two sets of eight data lines between the timing generation circuits 240 and the FPGAs 220, 230. The first set connects each of the eight timing generation circuits 240 to the FPGA 220 and the second set connects each of the eight timing generation circuits 240 to the FPGA 230. The FPGAs 220, 230 are also connected to their respective DIMMs 225, 235, and to the bus interface FPGA 210, which interfaces with the system bus 205.

The components of the digital instrument 130-1, shown in FIG. 2, function together, and with other components of the digital instrument 130-1 that are not illustrated, e.g., a power module, a parametric measurement unit (PMU) and a timing measurement unit (TMU), to generate test signals for the input digital pins of the DUT 190 and to receive and process response signals from the output digital pins of the DUT 190.

The digital instrument 130-1 strobes response signals from the output digital pins of the DUT 190 to generate a continuous stream of data bits that are to be compared (16 bits or 1 word at a time) against an expect data packet that is retrieved from the DIMM 235. The digital instrument 130-1 performs this test continuously, and issues a fail trigger each time there is a mismatch.

The timing generation circuits 240 store in memory a number of different time sets (or strobe markers) that they use to strobe the data streams from the digital pins of the DUT 190. The FPGA 230 selects a time set for each pin, in accordance with the bit synchronization method that is described below, and communicates its selections to the timing generation circuits 240 through the FPGA 220. When the timing generation circuits 240 receive the selections made by the FPGA 230, they retrieve the selected time sets from memory and strobe the data streams from the digital pins of the DUT 190 using the selected time sets.

Each time set stored in memory of the timing generation circuits 240 is offset from an adjacent time set by a fraction of the bit interval. In the embodiment of the invention described herein, 16 different time sets (Ts0, Ts1, . . . , Ts15) are stored in memory. If the bit rate of the data stream output by the DUT 190 is 2.5 Gigabits/second, the time interval between the time sets is 25 picoseconds. The following table illustrates the different time sets that are stored in memory. Each timing value stored in the table is defined in picoseconds relative to a system reference clock that is synchronized to the master clock 136.

| Ts0 | Ts1 | Ts2 | Ts3 | *** | Ts14 | Ts15 |
|---|---|---|---|---|---|---|
| 0 | 25 | 50 | 75 | | 350 | 375 |
| 400 | 425 | 450 | 475 | | 750 | 775 |
| 800 | 825 | 850 | 875 | | 1150 | 1175 |
| * | * | * | * | | * | * |
| * | * | * | * | | * | * |
| * | * | * | * | | * | * |

Before the strobed data stream of words is compared with expect data packets, it is necessary to align the data stream of words to the expect data packets. This process is known in the art as frame synchronization or frame alignment. This process needs to be separately performed because the digital instrument 130-1 begins generating the data stream of words from the response signals (a continuous stream of 0's and 1's) without regard to when the response signals that are to be converted and compared with the expect data packets begin arriving from the output digital pins of the DUT 190.

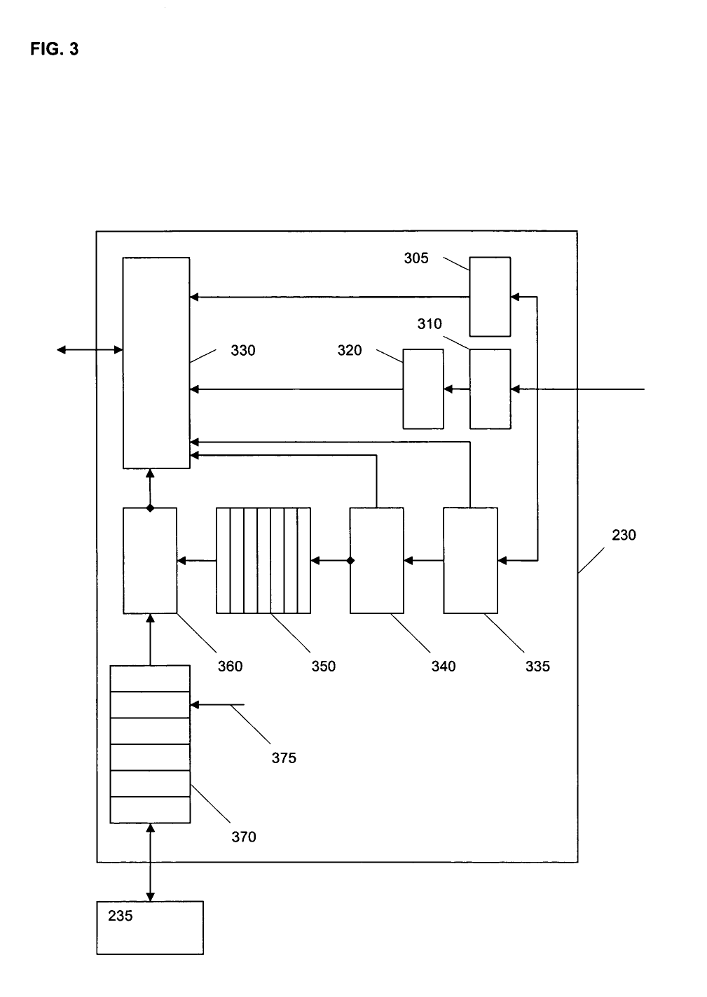

FIG. 3 is a block diagram illustrating the components of the FPGA 230 that processes a data stream from one of the eight timing generation circuits 240. The FPGA 230 includes seven additional copies of the circuit shown in FIG. 3 to process the data streams from the remaining seven timing generation circuits 240.

The FPGA 230 includes a bit synchronization module 305 for performing bit synchronization or eye centering, a frame synchronization module 310 for performing frame synchronization or frame alignment, a unit interval (UI) counter 320 that is incremented each time a word is received by the FPGA 230, a message block interface 330 for communicating with the FPGA 220, a synchronization detector 335 for detecting a synchronization code in the data stream, an idle detector 340 for detecting an idle code in the data stream of words received from the timing generation circuit 240, a high-speed buffer queue 350 for delaying the data stream of words prior to comparing them with an expect data packet, a comparator 360 for performing the comparison, and an address memory 370 that stores in a sequential manner the memory locations of expect data packets to be retrieved from the DIMM 235. The sequence of expect data packets to be retrieved from the DIMM 235 is specified by the test program.

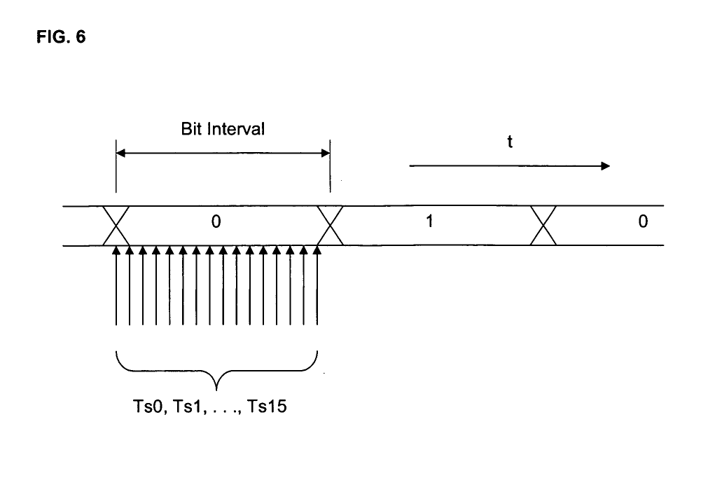

The bit synchronization module 305 receives the strobed data stream of words from the timing generation circuit 240. During the initialization phase of testing and during testing when the synchronization detector 335 detects a synchronization code in the data stream, the bit synchronization module 305 is active. When it is active, the bit synchronization module 305 selects the time sets (Ts0, Ts1, Ts2, . . . , Ts15) in sequence, communicates the selection to the timing generation circuit 240 through the message block interface 330 and FPGA 220, and counts the number of zeroes appearing in the data stream for a set period of time. After all 16 time sets have been selected and the number of zeroes associated with each of the time sets counted in this manner, the bit synchronization module 305 selects one of the time sets as the time set to be used during subsequent testing. The selection process is described below with reference to FIGS. 6-9.

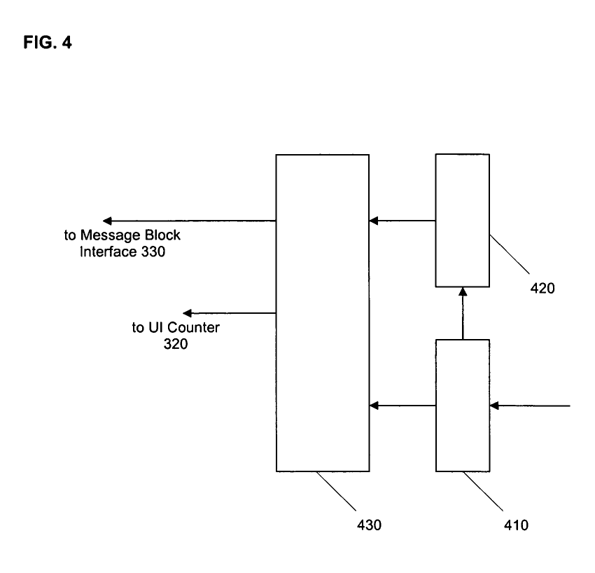

The frame synchronization module 310 is illustrated in further detail in FIG. 4. It includes word buffers 410, 420 and a 32-bit comparator 430. The comparator 430 looks for a frame synchronization code (e.g., a 5-bit code ‘01110’) in the 32-bit data formed by combining the words stored in the buffers 410, 420. By using a 32-bit comparator in this manner, the frame synchronization code can be found in the boundary between any two successive words. The table below shows the 32-bit data that is being compared with the 16-bit data received at the buffer 410 at successive points in time: t0, t1, t2, t3, . . . , t(n).

| Time | 16-bit data (C data) | 32-bit data |
|---|---|---|
| t0 | w0 | W0 + null |
| t1 | W1 | w1 + W0 |
| t2 | W2 | W2 + W1 |
| t3 | W3 | W3 + W2 |
| * | * | * |
| * | * | * |
| * | * | * |
| t(n) | W(n) | W(n) + W(n − 1) |

When the frame synchronization code is found, the UI counter 320 is initialized, and a frame synchronization detect message including a bit position corresponding to the start of a frame is sent to the message block interface 330. Frame synchronization is performed pin by pin. Therefore, each copy of the circuit shown in FIG. 3 has its own frame synchronized bit position stored in the message block interface 330.

After frame synchronization, the frame synchronization module 310 is not used, and the UI counter 320 is incremented each time a new word (corresponding to a set of 16-bits measured from the frame synchronized bit position) arrives from the corresponding timing generation circuit 240. Also, each time the UI counter 320 is incremented, the counter reading is communicated to the message block interface 330. The new word is also supplied to the idle detector 340 and stored in the high-speed buffer queue 350. The high-speed buffer queue 350 is configured as a first-in, first out (FIFO) buffer so that each time a new word arrives from the corresponding timing generation circuit 240, all of the words already in the buffer queue 350 advance one position away from the start position of the buffer towards the end position of the buffer, and the new word is stored in the start position of the buffer. When the arrival of the next new word causes the word stored at the end of the buffer to exit: (i) a pointer 375 associated with the address memory 370 is advanced once; (ii) an expect data packet is retrieved from the DIMM 235 at the memory location indicated by the pointer 375; and (iii) the comparator 360 performs a comparison of the exiting word against the retrieved data packet. If there is a mismatch, a fail trigger is issued to the message block interface 330.

A typical DUT may have one or two of its output digital pins designated as the pin(s) at which idle codes appear. If one pin is designated (e.g., Pin 0), the idle detector 340 associated with the stream of data packets corresponding to this pin is activated and looks for an idle code (e.g., ‘1111’) in each new word that it is supplied (e.g., in the 4 most significant bit positions). All other idle detectors are turned off. For example, an idle state will be determined in the following situation:

| | | | | | | | | | | | | | | | | |
|---|---|---|---|---|---|---|---|---|---|---|---|---|---|---|---|---|
| Pin 0 | 1 | 1 | 1 | 1 | 0 | 0 | 0 | 0 | 0 | 0 | 0 | 0 | 0 | 0 | 0 | 0 |
| bit position | 15 | 14 | 13 | 12 | 11 | 10 | 9 | 8 | 7 | 6 | 5 | 4 | 3 | 2 | 1 | 0 |

but not in the following situation:

| | | | | | | | | | | | | | | | | |
|---|---|---|---|---|---|---|---|---|---|---|---|---|---|---|---|---|
| Pin 0 | 1 | 1 | 1 | 0 | 0 | 1 | 1 | 1 | 1 | 0 | 0 | 0 | 0 | 0 | 0 | 0 |
| bit position | 15 | 14 | 13 | 12 | 11 | 10 | 9 | 8 | 7 | 6 | 5 | 4 | 3 | 2 | 1 | 0 |

If two pins are designated (e.g., Pin 0 and Pin 1), the two idle detectors 340 associated with the streams of data packets corresponding to the two pins are activated, and each of the two idle detectors 340 look for an idle code (e.g., ‘11’) in each new word that it is supplied (e.g., in the 2 most significant bit positions). All other idle detectors are turned off. If both idle detectors 340 find the idle code at the same time (or at the same counter reading), it is determined that the DUT 190 is under an idle state at that time. For example, an idle state will be determined in the following situation:

| | | | | | | | | | | | | | | | | |
|---|---|---|---|---|---|---|---|---|---|---|---|---|---|---|---|---|
| Pin 0 | 1 | 1 | 0 | 0 | 0 | 0 | 0 | 0 | 0 | 0 | 0 | 0 | 0 | 0 | 0 | 0 |
| Pin 1 | 1 | 1 | 0 | 0 | 0 | 0 | 0 | 0 | 0 | 0 | 0 | 0 | 0 | 0 | 0 | 0 |
| bit position | 15 | 14 | 13 | 12 | 11 | 10 | 9 | 8 | 7 | 6 | 5 | 4 | 3 | 2 | 1 | 0 |

but not in the following situation:

| | | | | | | | | | | | | | | | | |
|---|---|---|---|---|---|---|---|---|---|---|---|---|---|---|---|---|
| Pin 0 | 0 | 1 | 0 | 0 | 1 | 1 | 0 | 0 | 0 | 0 | 0 | 0 | 0 | 0 | 0 | 0 |
| Pin 1 | 1 | 1 | 1 | 1 | 1 | 1 | 0 | 0 | 0 | 0 | 0 | 0 | 0 | 0 | 0 | 0 |
| bit position | 15 | 14 | 13 | 12 | 11 | 10 | 9 | 8 | 7 | 6 | 5 | 4 | 3 | 2 | 1 | 0 |

When the idle state is determined, the UI counter reading associated with the word(s) in which the idle code was detected is stored in the message block interface 330. All words having the same UI counter reading are determined to be idle data packets and are not compared with expect data packets.

For example, assume there are two digital instruments, each connected to four output digital pins of the DUT 190. The streams of frame synchronized data packets generated from the response signals from these pins will be referred to as first through eighth streams. The first digital instrument processes the first through fourth streams, and the second digital instrument processes the fifth through eighth streams.

In the example, the first and second streams are examined for idle codes. When the idle code is detected in data packets in the first and second streams by the idle detectors 340, the counter reading of the UI counters 320 is stored at the message block interfaces 330 associated with the first and second streams and communicated to the message block interfaces 330 associated with the third and fourth streams internally through the FPGA 220, and communicated to the message block interfaces 330 associated with the fifth through eighth streams through the FPGA 220 of the first digital instrument, the bus interface FPGA 210 of the first digital instrument, the system bus 205, the bus interface FPGA 210 of the second digital instrument, and the FPGA 220 of the second digital instrument.

As the data packets in the third through eighth streams exit their corresponding high-speed buffer queues 350, the FPGA 230 examines the corresponding message block interface 330 to determine if the comparison of the exiting data packet should be suppressed. If the comparison is to be suppressed: (i) the expect data pointer 375 is not advanced; (ii) the expect data packet is not retrieved; and (iii) the comparator 360 does not compare the exiting data packet against any expect data packet. If the comparison is to be made: (i) the expect data pointer 375 is advanced once; (ii) the expect data packet is retrieved from the memory location of the DIMM 235 indicated by the expect data pointer 375; and (iii) the comparator 360 compares the exiting data packet against the retrieved expect data packet.

The determination of whether the comparison of the exiting data packet should be suppressed or performed is made with respect to the UI counter reading associated with the detection of an idle code, the size of the high-speed buffer queue 350, and the current UI counter reading. If the current UI counter reading is equal to the idle code UI counter reading+buffer size/16 bits, the comparison is to be suppressed. If not, the comparison is to be performed. In the preferred embodiment, the buffer size is 1024 bits. Therefore, an idle code that is detected at a particular point in time will affect the determination of whether the comparison of the exiting data packet should be suppressed or performed 64 counter increments after the particular point in time. If a new 16-bit word is processed every 5 nanoseconds, this means that the high-speed buffer queue 350 delays the comparison by 320 nanoseconds.

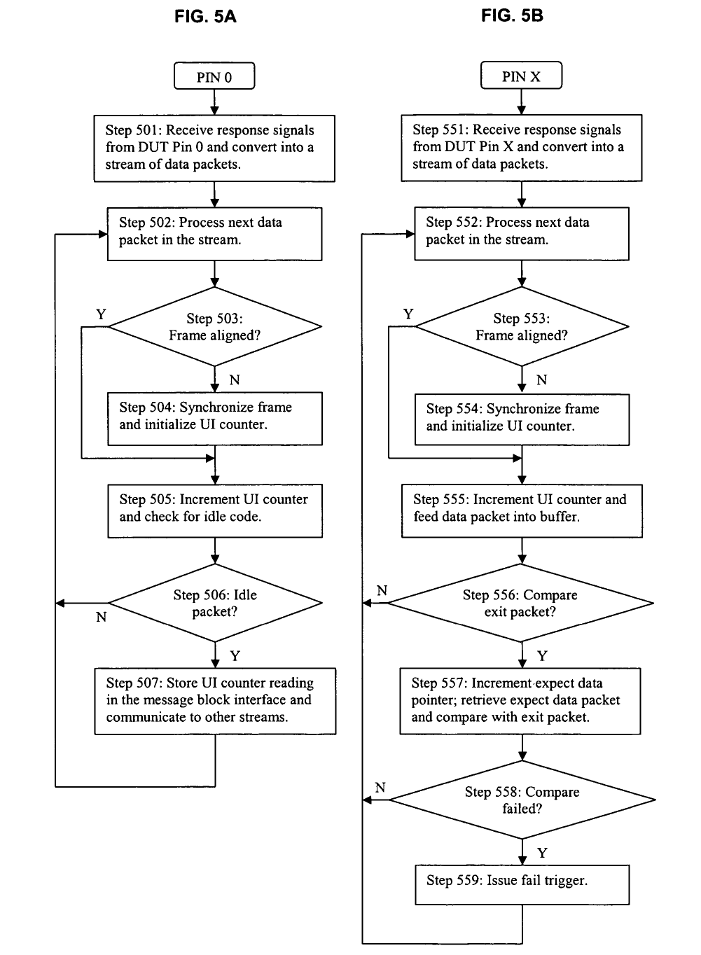

FIGS. 5A and 5B are flow diagrams that illustrate the test methodology according to the invention. FIG. 5A is a flow diagram that illustrates the processing of response signals generated by a pin (e.g., Pin 0) that is designated as the pin at which idle codes appear. FIG. 5B is a flow diagram that illustrates the processing of response signals generated by another pin (e.g., Pin X).

Referring to FIG. 5A, in Step 501, the timing generation circuit 240 corresponding to Pin 0 receives response signals from Pin 0 of the DUT 190 through the pin electronics circuit 250 and digitizes the signals into a stream of data packets. Steps 502-507 represent the processing of the data packets in the stream one at a time. In Step 503, the data packet being processed is checked for frame alignment. If the frame is aligned, the process jumps to Step 505. If the frame is not aligned, frame synchronization is performed using the frame synchronization module 310 (Step 504). Frame synchronization is performed only once for this stream so subsequent data packets in this stream that are processed go directly from Step 503 to Step 505. After frame synchronization, the UI counter 320 is incremented by one and the idle detector 340 examines the data packet for an idle code (Steps 505 and 506). If an idle code is detected, the counter reading at the UI counter 320 is stored in the message block interface 330 and communicated to the other data packet streams (Step 507); the flow then returns to Step 502 and the next data packet in the stream is processed. If an idle code is not detected, the flow returns to Step 502 and the next data packet in the stream is processed.

Referring to FIG. 5B, in Step 551, the timing generation circuit 240 corresponding to Pin X receives response signals from Pin X of the DUT 190 through the pin electronics circuit 250 and digitizes the signals into a stream of data packets. Steps 552-559 represent the processing of the data packets in the stream one at a time. In Step 553, the data packet being processed is checked for frame alignment. If the frame is aligned, the process jumps to Step 555. If the frame is not aligned, frame synchronization is performed using the frame synchronization module 310 (Step 554). Frame synchronization is performed only once for this stream so subsequent data packets in this stream that are processed go directly from Step 553 to Step 555. After frame synchronization, the UI counter 320 is incremented by one and the data packet is fed into the buffer queue 350 (Step 555). When the data packet is fed into the buffer queue 350, a data packet at the end of the buffer queue 350 exits the buffer queue, and a determination is made as to whether or not a comparison of this exit data packet and an expect data packet is to be suppressed or performed (Step 556). If the UI counter reading is equal to any of the idle code UI counter readings+buffer size/16 bits, the comparison is suppressed, and the flow returns to Step 552 where the next data packet is processed. If the UI counter reading is not equal to any of the idle code UI counter readings+buffer size/16 bits, the comparison is performed. Consequently, in Step 557, the expect data pointer 375 is incremented; the expect data packet is retrieved from the DIMM 235; and the exit data packet is compared with the expect data packet. If the comparison fails, a fail trigger is issued and the flow returns to Step 552 where the next data packet is processed (Steps 558 and 559). If the comparison is good, the fail trigger is not issued and the flow returns to Step 552 where the next data packet is processed.

Special idle message codes may be used in situations where the DUT 190 is expected to be in an idle state for more than one time interval or UI counter increment. For example, an idle message code ‘1001’ may be used as an idle code ON/OFF toggle so that all UI counter readings between the ON toggle and the OFF toggle, inclusive, are considered to be UI counter readings corresponding to an idle state of the DUT 190. As a consequence, all data packets corresponding to these UI counter readings will be considered idle data packets and will not be used in the comparisons against expect data packets.

FIG. 6 illustrates a bit stream of 0's and 1's that are output by the DUT 190 during the initialization phase of testing. Sixteen different pointers are shown in FIG. 6, each corresponding to one of the time sets (Ts0, Ts1, Ts2, . . . , Ts15) and representing a reference strobe point with respect to which all subsequent strobe points are defined. In other words, for any one time set, the strobing of the bit stream takes place at the same point in the bit interval as the reference strobe point.

The 16 different reference strobe points span the width of the bit interval and have equal spacing between them. The spacing is equal to the bit interval divided by the number of different reference strobe points. In the embodiment described herein, the spacing is 25 picoseconds (=400 picoseconds/16). In the illustration, the reference strobe point associated with the time set Ts0 is shown to be at the beginning of the bit interval. However, this is not necessarily the case. In practice, the reference strobe point associated with the time set Ts0 may be at any point along the bit interval.

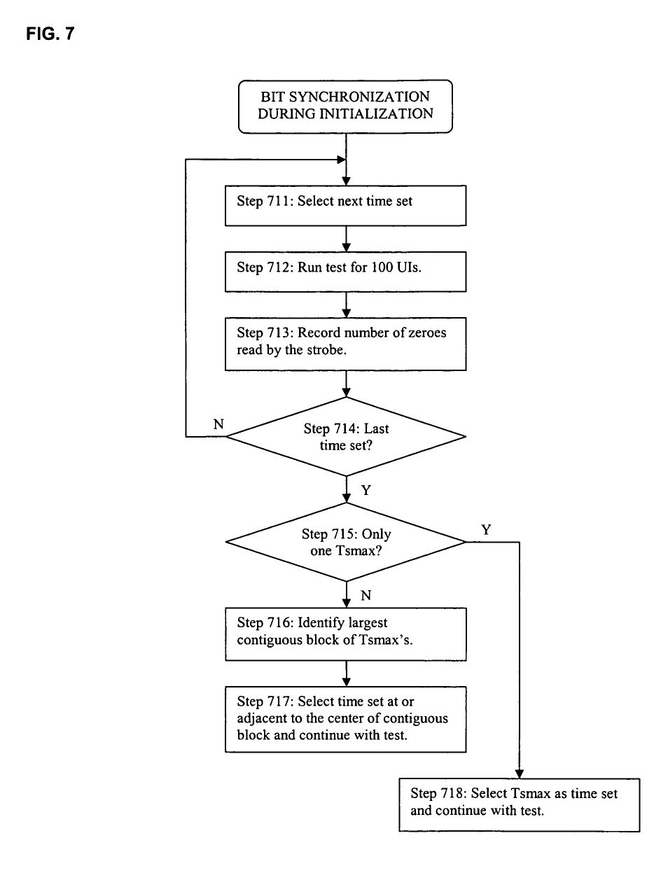

FIG. 7 is a flow diagram that illustrates the bit synchronization method carried out according to the invention. These steps are carried out for each output digital pin of the DUT 190 during the initialization phase of testing when it is alternately outputting 0's and 1's.

In Step 711, the next time set in sequence is selected by the FPGA 230. During the initial pass, the first time set Ts0 is selected. In Step 712, the timing generation circuit 240 strobes the data bit stream from the DUT 190 using the selected time set for 100 unit intervals (“UIs”; also referred to as bit intervals). The strobe rate is set to be equal to the bit rate of the DUT 190. Therefore, if the bit rate of the DUT 190 is 2.5 Gigabits/second, the data bit stream from the DUT 190 is strobed every 400 picoseconds.

In Step 713, the FPGA 230 records the number of zeroes in the data stream generated by the timing generation circuit 240 using the selected time set. Steps 711-713 are carried out for all 16 time sets. After the last time set (Step 714), the FPGA 230 identifies the time set that generated the most number of zeroes (Tsmax). If there are more than one Tsmax's (Step 715), the FPGA 230 identifies a largest contiguous block of Tsmax's (Step 716) and determines the time set that is at, or adjacent to, the center of this block as the time set to be used for subsequent strobing of the data (TsC) (Step 717). If there is only one Tsmax, the FPGA 230 determines Tsmax as the time set to be used for subsequent strobing of the data (Step 718).

Alternatively, if a contiguous block of Tsmax's appears at the beginning of the bit interval (e.g., Ts0, Ts1, Ts2, Ts3, Ts4) and at the end of the bit interval (e.g., Ts14, Ts15), the two contiguous blocks are combined into a single block (e.g., Ts14, Ts15, Ts0, Ts1, Ts2, Ts3, Ts4) and if this block is the largest of the contiguous blocks, the time set that is at, or adjacent to, the center of this block (e.g., Ts1) is selected as the time set to be used for subsequent strobing of the data.

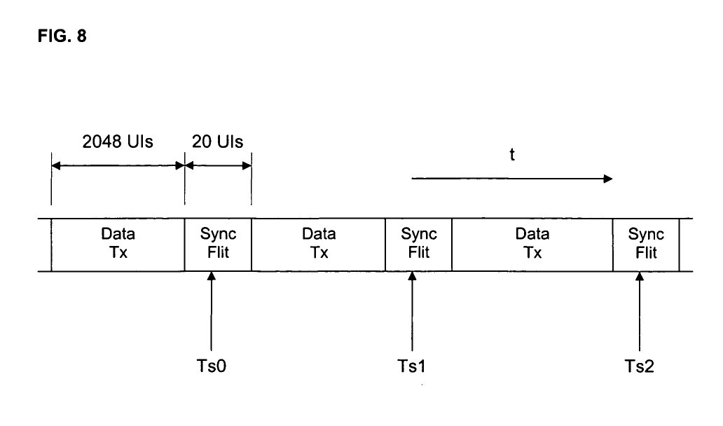

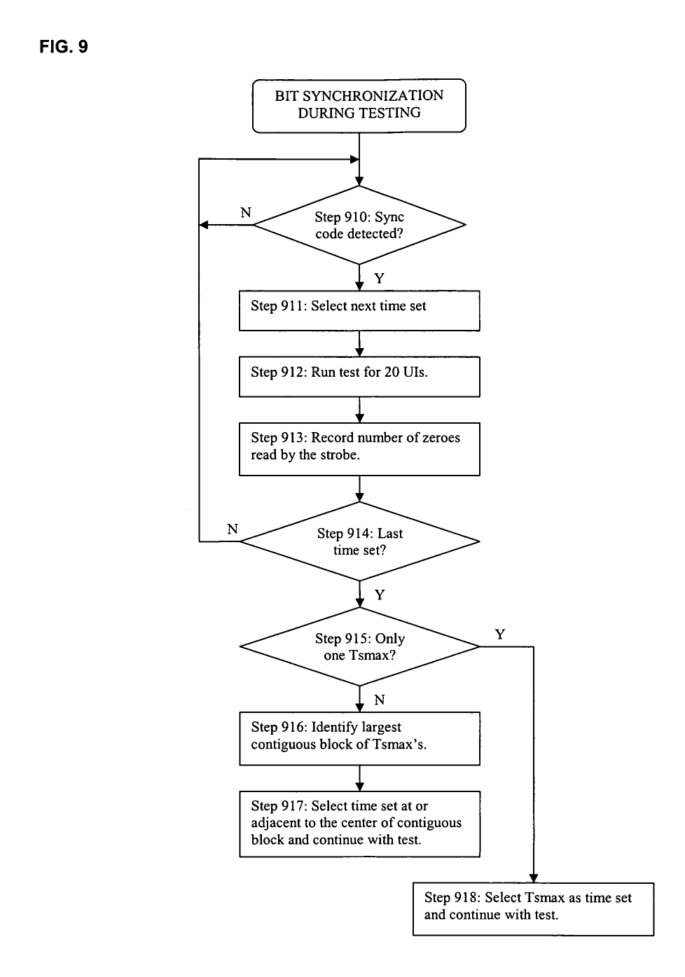

FIG. 8 illustrates a bit stream output by the DUT 190 during testing. During testing, the DUT 190 outputs a bit stream “Data Tx” during a normal testing state and outputs a synchronization code (e.g., “01101”) followed by a bit stream of alternating 0's and 1's during a synchronization state. In the embodiment of the invention described herein, the normal testing state is 2048 UIs long and the synchronization state is 20 UIs long. The synchronization detector 335 of the FPGA 230 examines the data stream of words received from the timing generation circuit 240 for the synchronization code. Upon detection, the FPGA 230 performs the bit synchronization method according to FIG. 9.

During any one synchronization interval (20 UIs), only one time set is selected from sixteen time sets (Ts0, Ts1, Ts2, . . . , Ts15). The time set Ts0 is selected during the first synchronization interval. The time set Ts1 is selected during the second synchronization interval and so forth until all sixteen time sets are selected.

FIG. 9 is a flow diagram that illustrates the bit synchronization method carried out intermittently while the testing of the DUT 190 is ongoing. These steps are carried out for each output digital pin of the DUT 190 during the synchronization interval when it is alternately outputting 0's and 1's.

In Step 910, the synchronization detector 335 continually checks for the synchronization code. If the synchronization code is detected, the next time set in sequence is selected by the FPGA 230 (Step 911). During the initial pass, the first time set Ts0 is selected. In Step 912, the timing generation circuit 240 strobes the data bit stream from the DUT 190 using the selected time set for 20 UIs. The strobe rate is set to be equal to the bit rate of the DUT 190. Therefore, if the bit rate of the DUT 190 is 2.5 Gigabits/second, the data bit stream from the DUT 190 is strobed every 400 picoseconds.

In Step 913, the FPGA 230 records the number of zeroes in the data stream generated by the timing generation circuit 240 using the selected time set. Steps 910-913 are carried out for all 16 time sets. After the last time set (Step 914), the FPGA 230 identifies the time set that generated the most number of zeroes (Tsmax). If there are more than one Tsmax's (Step 915), the FPGA 230 identifies a largest contiguous block of Tsmax's (Step 916) and determines the time set that is at, or adjacent to, the center of this block as the time set to be used for subsequent strobing of the data (TsC) (Step 917). If there is only one Tsmax, the FPGA 230 determines Tsmax as the time set to be used for subsequent strobing of the data (Step 918).

Alternatively, if a contiguous block of Tsmax's appears at the beginning of the bit interval (e.g., Ts0, Ts1, Ts2, Ts3, Ts4) and at the end of the bit interval (e.g., Ts14, Ts15), the two contiguous blocks are combined into a single block (e.g., Ts14, Ts15, Ts0, Ts1, Ts2, Ts3, Ts4) and if this block is the largest of the contiguous blocks, the time set that is at, or adjacent to, the center of this block (e.g., Ts1) is selected as the time set to be used for subsequent strobing of the data.

While the foregoing is directed to embodiments of the present invention, other and further embodiments of the invention may be devised without departing from the basic scope thereof, and the scope thereof is determined by the claims that follow.

What is claimed is:

1. An apparatus for testing electronic devices, comprising:
a drive circuit for generating signals to be supplied to a device under test in accordance with a test program;
a response circuit for receiving a stream of bits from the device under test and strobing the bits with respect to a reference strobe point to generate strobe readings; and
a programmable device for setting different reference strobe points, wherein the reference strobe points span one bit interval at regular intervals.

2. The apparatus according to claim 1, wherein the response circuit is configured to strobe the bits at a rate that is equal to a rate at which the bits are received by the response circuit.

3. The apparatus according to claim 2, wherein the programmable device is programmed to select one of the reference strobe points as a reference strobe point to be used during testing.

4. The apparatus according to claim 1, wherein the programmable device is programmed to select the reference strobe point that generates the most number of zeroes in the strobe readings as the reference strobe point to be used during testing.

5. The apparatus according to claim 1, wherein the programmable device is programmed to identify the reference strobe points that generate the most number of zeroes in the strobe readings as valid strobe points and select one of the valid strobe points as the reference strobe point to be used during testing.

6. The apparatus according to claim 5, wherein the programmable device is further programmed to identify a sequence of valid strobe points and determine the valid strobe point that is at or near the center of the sequence of valid strobe points as the reference strobe point to be used during testing.

7. An apparatus for testing electronic devices, comprising:
a drive circuit for generating signals to be supplied to a device under test in accordance with a test program;
a response circuit for receiving a stream of bits from the device under test and strobing the bits with respect to a first reference strobe point to generate strobe readings while the device under test is under a first state and with respect to a second reference strobe point to generate strobe readings while the device under test is under a second state; and
a programmable device for detecting whether the device under test is under the first state or the second state.

8. The apparatus according to claim 7, wherein the first state corresponds to a normal testing state and the second state corresponds to a synchronization state.

9. The apparatus according to claim 8, wherein the programmable device is programmed to cycle through a plurality of different second reference strobe points and set a different second reference strobe point each time it detects that the device under test transitions from the first state to the second state.

10. The apparatus according to claim 9, wherein the second reference strobe points span one bit interval at regular intervals.

11. The apparatus according to claim 10, wherein the programmable device is programmed to select the second reference strobe point that generates the most number of zeroes in the strobe readings as the first reference strobe point to be used during the first state.

12. The apparatus according to claim 10, wherein the programmable device is programmed to identify the second reference strobe points that generate the most number of zeroes in the strobe readings as valid strobe points and select one of the valid strobe points as the first reference strobe point to be used during the first state.

13. The apparatus according to claim 12, wherein the programmable device is further programmed to identify a sequence of valid strobe points and determine the valid strobe point that is at or near the center of the sequence of valid strobe points as the first reference strobe point to be used during the first state.

14. A method of testing electronic devices, comprising the steps of:
receiving a stream of bits from a device under test;
strobing the bits with respect to different reference strobe points to generate multiple sets of strobe readings, wherein the reference strobe points span one bit interval at regular intervals; and
selecting one of the reference strobe points as a reference strobe point to be used during testing.

15. The method according to claim 14, wherein the bits are strobed at a rate that is equal to a rate at which the bits are received.

16. The method according to claim 15, wherein the steps of strobing and selecting are carried out during initialization phase of testing.

17. The method according to claim 15, wherein the steps of strobing and selecting are carried out intermittently after the initialization phase of testing.

18. The method according to claim 14, further comprising the step of counting the number of zeroes in each of the sets of strobe readings, wherein the reference strobe point that generated the most number of zeroes is selected as the reference strobe point to be used during testing.

19. The method according to claim 14, further comprising the steps of counting the number of zeroes in each of the sets of strobe readings and identifying the reference strobe points that generated the most number of zeroes as valid strobe points, wherein one of the valid strobe points is selected as the reference strobe point to be used during testing.

20. The method according to claim 19, further comprising the step of identifying a sequence of valid strobe points, wherein the valid strobe point that is at or near the center of the sequence of valid strobe points is selected as the reference strobe point to be used during testing.
